(19) United States
(12) Patent Application Publication
(10) Pub. No.: US 2025/0012938 A1
(43) Pub. Date: Jan. 9, 2025

(54) SEISMIC SENSOR, EARTHQUAKE DETECTION METHOD, AND EARTHQUAKE DETECTION PROGRAM

(71) Applicant: OMRON CORPORATION, Kyoto-shi (JP)

(72) Inventors: Shogo SHIGEMOTO, Kyoto-shi (JP); Akinori NARUMIYA, Kyoto-shi (JP); Masashi SATO, Kyoto-shi (JP); Hideyuki URATA, Kyoto-shi (JP)

(73) Assignee: OMRON CORPORATION, Kyoto-shi (JP)

(21) Appl. No.: 18/757,779

(22) Filed: Jun. 28, 2024

(30) Foreign Application Priority Data
Jul. 4, 2023 (JP) 2023-109983

(51) Int. Cl. G01V 1/01; G01V 1/16; G01V 1/30; G01V 1/36

(52) U.S. Cl. CPC G01V 1/01; G01V 1/16; G01V 1/307; G01V 1/364

(57) ABSTRACT

A seismic sensor 10 comprises an acceleration acquisition unit 21, an earthquake determination unit 25, an offset adjustment unit 29, a convergence determination unit 29a, and an origin correction necessity determination unit 29b. After the detection of noise included in the vibration detected by the earthquake determination unit 25, the offset adjustment unit 29 adjusts the offset amount according to the magnitude of the vibration. The convergence determination unit 29a determines whether or not the vibrations have converged. The origin correction necessity determination unit 29b determines whether or not to perform the origin correction of acceleration according to whether or not the offset amount calculated according to the magnitude of the vibration after noise was detected is about the same as the previous offset amount, at the point when a specific period has elapsed since the time when the convergence determination unit 29a determined that the vibrations had converged.

### CROSS-REFERENCE TO RELATED APPLICATIONS

THIS APPLICATION CLAIMS PRIORITY TO JAPANESE PATENT APPLICATION NO. 2023-109983 FILED ON Jul. 4, 2023. THE ENTIRE DISCLOSURE OF JAPANESE PATENT APPLICATION NO. 2023-109983 IS HEREBY INCORPORATED HEREIN BY REFERENCE.

### TECHNICAL FIELD

The present invention relates to a seismic sensor, an earthquake detection method, and an earthquake detection program with which seismic motion is detected.

### BACKGROUND ART

Recent years have witnessed the use of seismic sensors that are built into gas meters, electricity meters, distribution boards, electrical outlets, and so forth and output a cutoff signal for cutting off the supply of gas, electricity, etc., in the event that seismic motion of at least a specific magnitude (such as a seismic intensity of 5 or higher).

For example, Patent Literature 1 discloses a seismic sensor comprising an earthquake determination unit that changes from a power saving mode to a measurement mode in which power consumption is higher when the measured acceleration exceeds a specific threshold, and determines whether an earthquake has occurred on the basis of the acceleration during the subsequent determination period, and an index calculation unit that calculates an index value indicating the intensity of the earthquake during an earthquake processing period following the determination period if the earthquake determination unit has determined that an earthquake has occurred, wherein this seismic sensor outputs a cutoff signal when the index value is at or above a threshold during the earthquake processing period, the seismic sensor further comprising a continuous earthquake determination unit that determines the occurrence of an earthquake on the basis of the acceleration measured during an earthquake processing period, and a cutoff determination unit that prevents a cutoff signal from being outputted regardless of the index value when the determination unit determines that an earthquake has not occurred.

With this seismic sensor, it is less likely that noise will be erroneously determined to be an earthquake, and that a cutoff signal will be erroneously outputted.

### CITATION LIST

### Patent Literature

Patent Literature 1: Japanese Patent No. 6,465,257

### SUMMARY OF INVENTION

### Technical Problem

However, the following problem is encountered with the conventional seismic sensor described above.

That is, with the seismic sensor disclosed in the above document, after determining an earthquake, it is determined that the vibrations have converged, and the offset amount is instantly adjusted once the vibrations converge. Therefore, if, for example, the detected vibration was a low-frequency vibration, etc., and the sensor was temporarily tilted, and the tilting then decreased, it was difficult to maintain good determination accuracy through offset adjustment when the adjustment was made immediately after the convergence of the vibrations.

It is an object of the present invention to provide a seismic sensor, an earthquake detection method, and an earthquake detection program with which vibration determination can be performed very accurately by eliminating the influence of temporary tilting that occurs immediately after the occurrence of vibration.

### Technical Solution

The seismic sensor according to the first invention comprises an acceleration acquisition unit, an earthquake determination unit, an offset adjustment unit, a convergence determination unit, and an origin correction necessity determination unit. The acceleration acquisition unit detects vibration and acquires the acceleration of the vibration. The earthquake determination unit determines whether or not the vibration is an earthquake on the basis of the acceleration acquired by the acceleration acquisition unit. The offset adjustment unit adjusts the offset amount according to the magnitude of the vibration after the detection of noise included in the vibration detected by the earthquake determination unit. The convergence determination unit determines whether the vibrations have converged. The origin correction necessity determination unit determines whether or not to perform origin correction of the acceleration according to whether or not the offset amount calculated according to the magnitude of the vibration after the noise was detected is the same as the previous offset amount once a specific length of time has elapsed since the point when the convergence determination unit determined that the vibrations had converged.

Here, in a seismic sensor that determines whether or not detected vibration is an earthquake on the basis of the acceleration of the vibration, and adjusts the offset amount to eliminate the influence of noise according to the magnitude of the vibration after noise is detected, any tilting of the seismic sensor is detected and it is determined whether or not to perform origin correction according to whether or not the offset amount calculated after a specific period of time (such as 5 to 20 seconds) has elapsed since the time when the vibrations were determined to have converged is the same as the previous offset amount.

Here, the previous offset amount that is compared with the newly calculated offset amount according to the magnitude of vibration after detecting noise refers to the offset amount calculated when vibration was detected the last time, such as an offset amount stored in the seismic sensor.

Also, low-frequency vibration is an example of vibration in which the tilting of the seismic sensor returns to normal after a specific period of time has elapsed.

Consequently, if it is determined that the current offset amount is about the same as the previous offset amount after a specific period of time (such as 5 to 20 seconds) has elapsed since the vibrations converged, it is presumed that there is almost no tilting of the seismic sensor, but if the difference is large compared to the previous offset amount, it is presumed that there is a high probability that the seismic sensor is still tilted.

Therefore, after the vibrations have converged, if this state continues for at least a specific length of time, the offset amount including origin correction is adjusted in this tilted state, and if the tilting does not continue for the specific length of time, the new offset amount in which the tilting has returned to normal can be used to perform offset adjustment.

As a result, vibrations can be evaluated very accurately by eliminating the influence of temporary tilting that occurs immediately after vibrations occur.

The seismic sensor according to the second invention is the seismic sensor according to the first invention, wherein, when the offset amount is about the same as the previous offset amount, the offset adjustment unit performs offset adjustment using the new offset amount.

Consequently, if it is determined that the current offset amount is about the same as the previous offset amount within a specific period (such as 5 to 20 seconds) since the vibrations converged, it is presumed that there is substantially no tilting of the seismic sensor, so the newly calculated offset amount can be used to perform offset adjustment.

The seismic sensor according to the third invention is the seismic sensor according to the first or second invention, wherein, once the specific length of time has elapsed, the offset adjustment unit uses an offset amount that is larger than the previous offset amount to perform offset adjustment including origin correction of the acceleration.

Consequently, if the current offset amount differs greatly from the previous offset amount for a specific period of time (such as 5 to 20 seconds) after the vibrations have converged, it is presumed that there is a high probability that the seismic sensor is still tilted, so the offset adjustment can be performed using the new offset amount.

Therefore, when the seismic sensor is maintained in a tilted state, performing the origin correction while taking the tilting into account allows the proper correction to be performed in the tilted state.

The seismic sensor according to the fourth invention is the seismic sensor according to the first or second invention, wherein the convergence determination unit determines whether or not the vibrations have converged after a specific time has elapsed since the determination by the earthquake determination unit.

Consequently, it is determined whether or not the detected vibration is an earthquake, and it is determined whether or not the vibrations have converged after a specific period of time has elapsed, so it can be easily determined whether the seismic sensor was just temporarily tilted by the vibration, or is still tilted.

The seismic sensor according to the fifth invention is the seismic sensor according to the first or second invention, wherein, when the origin correction necessity determination unit determines that origin correction is necessary, the offset adjustment unit performs origin correction of acceleration in a horizontal plane to correct deviation in the direction of gravitational acceleration.

Consequently, correcting the origin of the acceleration in a horizontal plane that has shifted due to the tilting of the seismic sensor allows origin correction to be performed while taking into account the tilting of the seismic sensor, so determination accuracy can be maintained.

The seismic sensor according to the sixth invention is the seismic sensor according to the first or second invention, wherein the offset adjustment unit adjusts the offset amount when the earthquake determination unit determines that the vibration is not an earthquake.

Consequently, the proper offset adjustment can be performed according to the magnitude of vibrations that are not from an earthquake.

The seismic sensor according to the seventh invention is the seismic sensor according to the first or second invention, further comprising a main body part to which the acceleration acquisition unit is provided. The origin correction necessity determination unit determines whether the main body part is tilted after the vibrations have converged, according to whether or not the offset amount is about the same as the previous offset amount.

This makes it easy to determine whether or not the main body part of the seismic sensor is itself tilted due to vibration by determining whether or not the newly calculated offset amount is the same as the previous offset amount.

The seismic sensor according to the eighth invention is the seismic sensor according to the first or second invention, further comprising an acceleration waveform generation unit that generates an acceleration waveform indicating the relation between elapsed time and the acceleration acquired by the acceleration acquisition unit.

This allows earthquake determination, offset adjustment, determination of whether or not origin correction is necessary, and so forth to be performed using the acceleration waveform generated from the acceleration of the detected vibration.

The seismic sensor according to the ninth invention is the seismic sensor according to the eighth invention, further comprising a frequency sensing unit that senses the frequency of the acceleration waveform generated in the acceleration waveform generation unit.

This allows the frequency detected from the acceleration waveform to be used to perform earthquake determination, offset adjustment, determination of whether or not origin correction is necessary, and so on.

The seismic sensor according to the tenth invention is the seismic sensor according to the ninth invention, wherein the earthquake determination unit determines whether or not the vibration is an earthquake on the basis of the frequency sensed by the frequency sensing unit.

This allows the frequency sensed from the acceleration waveform to be used to perform earthquake determination to determine whether or not vibration is an earthquake.

The seismic sensor according to the eleventh invention is the seismic sensor according to the first or second invention, further comprising an earthquake magnitude calculation unit that determines whether or not the earthquake is at or over a specific seismic level when the earthquake determination unit has determined that it is an earthquake.

Consequently, if the magnitude of an earthquake is determined to be a seismic intensity of 5 or higher, for example, there is a risk that fire, a gas leak, or the like will occur, and user safety can be enhanced by outputting a cutoff signal to halt the supply of energy such as electricity or gas.

The seismic sensor according to the twelfth invention is the seismic sensor according to the first invention, further comprising an output unit that outputs a specific signal when the earthquake determination unit has determined that it is an earthquake.

Consequently, in the event of an earthquake, for example, a cutoff signal to stop the supply of energy such as electricity or gas, a warning signal to alert the user of danger, etc., can be outputted from the output unit.

The seismic sensor according to the thirteenth invention is the seismic sensor according to the eleventh invention, further comprising an output unit that outputs a specific signal when the earthquake determination unit has determined that it is an earthquake, and further comprising an output control unit that controls the output of the signal from the output unit according to whether the magnitude of the earthquake calculated by the earthquake magnitude calculation unit is at or above a specific seismic level.

Consequently, if the earthquake magnitude calculation unit calculates that the magnitude of the earthquake is greater than 5 (specific seismic intensity), for example, a cutoff signal to halt the supply of energy such as electricity or gas, a warning signal to alert the user of danger, etc., can be outputted from the output unit.

The seismic sensor according to the fourteenth invention is the seismic sensor according to the twelfth invention, wherein the specific signal is a cutoff signal that halts the supply of energy.

Consequently, if an earthquake of a specific seismic intensity or higher is detected, for example, the supply of energy such as electricity or gas can be halted.

The seismic sensor according to the fifteenth invention is the seismic sensor according to the twelfth invention, wherein the specific signal is a warning signal that gives a warning to the user.

Consequently, if an earthquake of a specific seismic intensity or higher is detected, for example, a warning signal can be emitted to alert the user of the danger.

The seismic sensor according to the sixteenth invention is the seismic sensor according to the first or second invention, further comprising a storage unit that stores the offset amount.

This allows the previous offset amount to be extracted from the storage unit provided in the seismic sensor, this to be compared with the newly calculated offset amount, and whether or not the origin correction is necessary to be determined.

The earthquake detection method according to the seventeenth invention comprises an acceleration acquisition step, an earthquake determination step, an offset adjustment step, a convergence determination step, and an origin correction necessity determination step. The acceleration acquisition step involves detecting vibration and acquiring the acceleration of the vibration. The earthquake determination step involves determining whether or not the vibration is an earthquake on the basis of the acceleration of the vibration acquired in the acceleration acquisition step. The offset adjustment step involves adjusting the offset amount according to the magnitude of the vibration after the detection of noise included in the vibration detected in the earthquake determination step. The convergence determination step involves determining whether or not the vibrations have converged. The origin correction necessity determination step involves determining whether or not the origin correction of the acceleration is to be performed, according to whether or not the offset amount calculated according to the magnitude of the vibration after the detection of noise is the same as the previous offset amount, at the point when a specific length of time has elapsed since the time when it was determined in the convergence determination step that the vibrations had converged.

Here, in an earthquake detection method in which vibration is determined to be an earthquake on the basis of the acceleration of detected vibration, and the offset amount is adjusted to eliminate the influence of noise according to the magnitude of the vibration after noise is detected, whether or not the seismic sensor is tilted is detected, and whether or not to perform origin correction is determined, according to whether or not the offset amount calculated after a specific period of time (such as 5 to 20 seconds) has elapsed since the time when it was determined that the vibrations had converged is the same as the previous offset amount.

Here, the previous offset amount that is compared to the newly calculated offset amount according to the magnitude of vibration after detecting noise refers to the offset amount calculated when vibration was detected the last time, such as an offset amount stored in the seismic sensor.

Also, the vibration in which the tilting of the seismic sensor returns to normal after a specific period of time has elapsed could be low-frequency vibration, for example.

Consequently, if the current offset amount is determined to be about the same as the previous offset amount after a specific period of time has elapsed since the vibrations converged, it is presumed that there is substantially no tilting of the seismic sensor, but if the difference is large compared to the previous offset amount, it is presumed that there is a high probability that the seismic sensor is still tilted.

Therefore, if tilting continues for at least a specific length of time after the vibration has converged, the offset amount including origin correction is adjusted in this tilted state, and if the tilting has not continued for a specific length of time, offset adjustment can be performed using the new offset amount in which the tilting has returned to normal.

As a result, vibration can be evaluated very accurately by eliminating the influence of temporary tilting that occurs immediately after the vibrations occur.

The earthquake detection program according to the eighteenth invention causes a computer to execute an earthquake detection program comprising an acceleration acquisition step, an earthquake determination step, an offset adjustment step, a convergence determination step, and an origin correction necessity determination step. The acceleration acquisition step involves detecting vibration and acquiring the acceleration of the vibration. The earthquake determination step involves determining whether or not the vibration is an earthquake on the basis of the acceleration of the vibration acquired in the acceleration acquisition step. The offset adjustment step involves adjusting the offset amount according to the magnitude of the vibration after the detection of noise included in the vibration detected in the earthquake determination step. The convergence determination step involves determining whether or not the vibrations have converged. The origin correction necessity determination step involves determining whether or not the origin correction of the acceleration is to be performed, according to whether or not the offset amount calculated according to the magnitude of the vibration after the detection of noise is the same as the previous offset amount, at the point when a specific length of time has elapsed since the time when it was determined in the convergence determination step that the vibrations had converged.

Here, in an earthquake detection program that determines whether or not a detected vibration is an earthquake on the basis of the acceleration of the vibration, and adjusts the offset amount to eliminate the influence of noise according to the magnitude of the vibration, the presence of tilting of the seismic sensor is detected and it is determined whether or not to perform origin correction, according to whether or not the offset amount calculated after a specific period of time has elapsed (such as 5 to 20 seconds) since the time when it was determined that the vibration had converged is about the same as the previous offset amount.

Here, the previous offset amount that is compared with the newly calculated offset amount according to the magnitude of vibration after detecting noise refers to the offset amount calculated when vibration was detected the last time, such as an offset amount stored in the seismic sensor.

Also, low-frequency vibration is an example of vibration in which the tilting of the seismic sensor returns to normal after a specific period of time has elapsed.

Consequently, if it is determined that the current offset amount is about the same as the previous offset amount after a specific period of time (such as 5 to 20 seconds) has elapsed since the vibrations converged, it is presumed that there is almost no tilting of the seismic sensor, but if the difference is large compared to the previous offset amount, it is presumed that there is a high probability that the seismic sensor is still tilted.

Therefore, after the vibrations have converged, if this state continues for at least a specific length of time, the offset amount including origin correction is adjusted in this tilted state, and if the tilting does not continue for the specific length of time, the new offset amount in which the tilting has returned to normal can be used to perform offset adjustment.

As a result, vibrations can be evaluated very accurately by eliminating the influence of temporary tilting that occurs immediately after vibrations occur.

### Advantageous Effects

With the seismic sensor according to the present invention, vibrations can be evaluated very accurately by eliminating the influence of temporary tilting that occurs immediately after vibrations occur.

### BRIEF DESCRIPTION OF THE DRAWINGS

FIG. 1 is a control block diagram showing the configuration of the seismic sensor according to an embodiment of the present invention;

FIG. 2 is a block diagram of the functions of the seismic sensor in FIG. 1;

FIG. 3A is a graph of the acceleration waveform when a specific period of time has elapsed while the offset amount is larger than the previous offset amount after it was determined that a detected vibration was not an earthquake, and FIG. 3B is a graph of the acceleration waveform when the offset amount was larger than the previous offset amount after it was determined that the detected vibration was not an earthquake, but came back to being about the same as the previous offset amount once a specific period of time had elapsed;

FIG. 4A is a graph of the state when an origin shift has occurred in the horizontal plane (X axis, Y axis) due to tilting of the seismic sensor, and FIG. 4B is a graph of the state when the acceleration on both the X axis and the Y axis has been offset from the state in FIG. 4A due to origin correction;

FIG. 5 is a flowchart showing the main flow of processing in an earthquake detection method using the seismic sensor of FIG. 1; and

FIG. 6 is a flowchart showing the detailed flow of the offset adjustment process in FIG. 5.

### BEST MODE FOR CARRYING OUT THE INVENTION

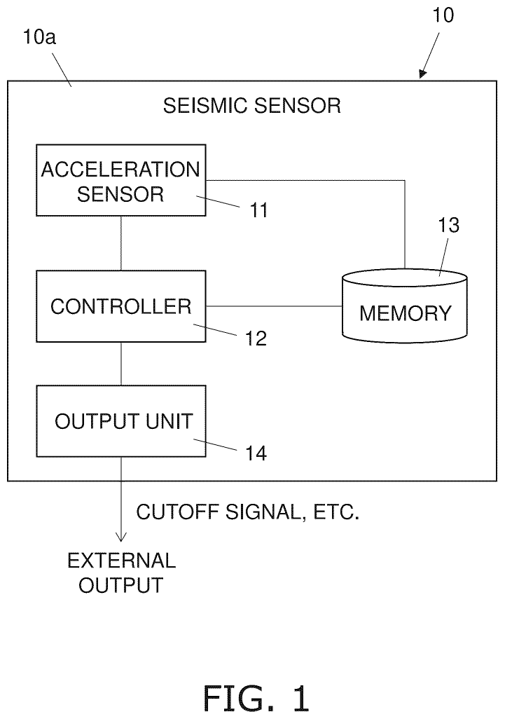

The seismic sensor according to an embodiment of the present invention will now be described through reference to FIGS. 1 to 6.

In this embodiment, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### (1) Configuration of Seismic Sensor 10

As shown in FIG. 1, the seismic sensor 10 according to this embodiment comprises an acceleration sensor 11, a controller 12, and a memory 13, all in a main body part 10a.

The acceleration sensor 11 is, for example, an acceleration sensor featuring a piezoelectric element, or an acceleration sensor that senses the capacitance between electrodes. The acceleration measured (also called “sampling”) by the acceleration sensor 11 is outputted to the controller 12.

The controller 12 is, for example, a general-purpose integrated circuit, and acquires the acceleration measured by the acceleration sensor 11 at specific intervals, detects the occurrence of an earthquake on the basis of the acquired acceleration, and calculates an index value indicating the magnitude of the earthquake.

Also, the controller 12 operates in different modes, namely, an active mode and a sleep mode, depending on the situation.

The sleep mode is a mode in which the controller 12 operates to limit functionality, such as accepting interruptions while halting the execution of commands, or stopping clock supply. In this sleep mode, power consumption is lower than that in the active mode.

Also, the active mode is a mode in which processing is performed to determine whether the detected vibration is an earthquake or just noise, or in which an index value indicating the magnitude of an earthquake is calculated.

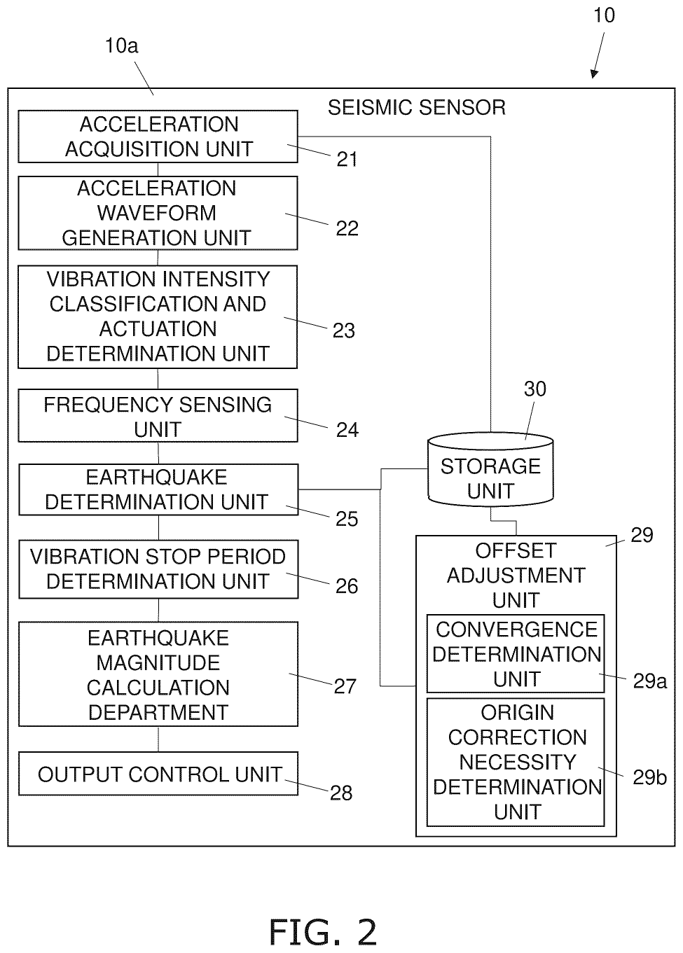

The functional blocks (see FIG. 2) generated by the CPU in the seismic sensor 10 by reading an earthquake detection program stored in the memory 13 will be described in detail below.

The memory 13 is a temporary storage means such as a RAM (random access memory), or a non-volatile memory such as an EPROM (erasable programmable read-only memory), and stores threshold values and the like that are used, for example, for earthquake determination or the acceleration measured by the acceleration sensor 11

The memory 13 may also be a memory that is built into the acceleration sensor 11 or the controller 12.

The output unit 14 is, for example, an output terminal had by the controller 12, and when the controller 12 determines that an earthquake has occurred, for example, information indicating the occurrence and magnitude of the earthquake is outputted to another device via the output unit 14. Also, when an earthquake of at least a specific magnitude is detected, the output unit 14 outputs a cutoff signal for halting the supply of energy, such as electricity or gas, to an external device, for example.

### (2) Functional Blocks of Seismic Sensor 10

As shown in FIG. 2, the seismic sensor 10 comprises an acceleration acquisition unit 21, an acceleration waveform generation unit 22, a vibration intensity classification and actuation determination unit 23, a frequency sensing unit 24, an earthquake determination unit 25, a vibration stop period determination unit 26, an earthquake magnitude calculation unit 27, an output control unit 28, an offset adjustment unit 29, and a storage unit 30, all inside a main body part 10a.

The acceleration acquisition unit 21 acquires measurement data about acceleration measured by the acceleration sensor 11 at specific intervals. The acceleration acquisition unit 21 usually acquires acceleration measurement data that is repeatedly measured at a relatively low speed (that is, at relatively long measurement intervals).

When acceleration sampling is performed at such a low speed, the controller 12 basically operates in sleep mode (standby state or power saving mode) in which the power consumption is reduced. Since a standby state is an operating state in which the acceleration sensor 11 performs sampling at low speed, the controller 12 operates in sleep mode with limited functions, and this reduces power consumption.

Also, when the acceleration acquisition unit 21 acquires a vibration that is over the threshold value preset in the storage unit 30, the acceleration sensor 11 repeatedly measures the acceleration at a higher speed (that is, at relatively short intervals) than during low-speed sampling. With such high-speed sampling, the controller 12 operates in sleep mode or active mode.

When the earthquake determination unit 25 and the like execute processing as described below, the controller 12 operates in active mode (measurement mode). Also, the transition from power saving mode to measurement mode is called actuation of the seismic sensor 10.

Measurement mode is an operating state in which high-speed sampling is performed, so the controller 12 may operate in sleep mode with limited functionality, or in active mode in which it can operate at maximum computing power. In measurement mode, the sampling period is shorter and the controller 12 is switched from sleep mode to active mode, so power consumption is higher than in power saving mode.

The acceleration waveform generation unit 22 generates an acceleration waveform indicating the relation between elapsed time and the acceleration measured by the acceleration acquisition unit 21.

The vibration intensity classification and actuation determination unit 23 compares the acceleration value acquired by the acceleration acquisition unit 21 with an actuation threshold held in the storage unit 30, and if the acceleration value exceeds the actuation threshold, the power mode is switched to the measurement mode (the seismic sensor 10 is actuated).

Also, the vibration intensity classification and actuation determination unit 23 is a function on the acceleration sensor 11 side, and calculates the intensity of vibration from the acquisition result at the acceleration acquisition unit 21, and if the vibration intensity is at or above a specific level, the power saving mode is switched to the measurement mode (the controller 12 is actuated) in which power consumption is higher than in power saving mode.

Here, the vibration intensity classification processing performed by the vibration intensity classification and actuation determination unit 23 is accomplished by subjecting the acceleration value acquired by the acceleration acquisition unit 21 to filtering. At this point, the filtered acceleration is stored in the storage unit 30.

With the seismic sensor 10 in this embodiment, the vibration intensity classification and actuation determination unit 23 that performs filtering functions as a so-called digital filter, and an existing technique can be employed for the filtering. The vibration intensity classification and actuation determination unit 23 functions as a low-pass filter by calculating the moving average of the absolute value of acceleration, for example.

The frequency sensing unit 24 senses the frequency of the acceleration waveform generated by the acceleration waveform generation unit 22.

The earthquake determination unit 25 determines whether or not the acceleration waveform whose frequency has been sensed should be subjected to earthquake determination, while determining whether or not the vibration with this acceleration waveform is an earthquake, on the basis of the frequency sensed by the frequency sensing unit 24.

More specifically, if the acceleration waveform has attenuated to a vibration equivalent to a specific seismic intensity or less within a specific length of time (for example, the maximum value of vibration acceleration—the minimum value<100 gal), the earthquake determination unit 25 excludes the acceleration waveform from earthquake determination.

Also, if the sensed frequency of the acceleration waveform is at or above a specific value and the fluctuation of the period (frequency) is at or below a specific value, the earthquake determination unit 25 excludes the acceleration waveform from earthquake determination.

Furthermore, for example, if the amplitude of the acceleration waveform sensed by the peak method is at or above a specific value and the frequency is at or above a specific value, the earthquake determination unit 25 excludes the acceleration waveform from earthquake determination.

In this embodiment, the earthquake determination unit 25 defines one or more determination periods after an acceleration exceeding the actuation threshold is detected, and performs processing for each determination period.

The vibration stop period determination unit 26 determines whether or not there is a period in which the vibration has stopped in the acceleration waveform after the earthquake determination unit 25 determines that there is an earthquake.

The determination of whether or not there is a period in which the vibration has stopped in the acceleration waveform may be made, for example, depending on whether or not there is a period in which the acceleration drops to zero, or on whether or not the acceleration falls within a specific threshold range.

If the earthquake determination unit 25 has determined that there is an earthquake, the earthquake magnitude calculation unit 27 determines whether or not the earthquake is equivalent to a specific seismic intensity or higher.

Also, if the detected vibration is determined to be an earthquake and an acceleration waveform that can be considered as a jolt is detected after the calculation of an index indicating the magnitude of the earthquake has begun, the earthquake magnitude calculation unit 27 excludes that acceleration waveform in its calculation of the magnitude of the earthquake.

At this point, the frequency sensing unit 24 senses, by the peak method, the frequency used to determine whether the detected acceleration waveform can be regarded as a jolt, for example.

The output control unit 28 controls the output of the signal from the output unit 14 that outputs a specific signal, according to whether or not the magnitude of the earthquake calculated by the earthquake magnitude calculation unit 27 is at or above a specific seismic intensity.

Here, the specific signal outputted from the output unit 14 includes, for example, a cutoff signal that is transmitted to an external device, such as an electricity supply device or a gas supply device, in order to halt the supply of electricity, gas, or other such energy.

If the earthquake determination unit 25 determines that the vibration detected by the acceleration acquisition unit 21 is noise, the offset adjustment unit 29 adjusts the offset amount of the acceleration waveform each time noise is detected. Also, if the vibration acquired by the acceleration acquisition unit 21 is determined by the earthquake determination unit 25 not to be an earthquake, the offset adjustment unit 29 calculates the offset amount according to the magnitude of the vibration after noise is detected, and adjusts the offset amount of the acceleration waveform.

The offset adjustment performed by the offset adjustment unit 29 involves detecting as the offset component any noise component included in the measured acceleration, such as the amount of change in the measured value that occurs due to changes in the seismic sensor 10 over time, the amount of change in the measured value caused by temperature changes, or the amount of change in the measured value that occurs due to changes in the direction of gravitational acceleration with respect to the installed seismic sensor 10 when the attitude of the sensor 10 is tilted for some reason. More specifically, the offset adjustment unit 29 calculates as the offset component the median value of the maximum and minimum acceleration values determined to be noise, or the average value of the acceleration, for example.

Offset adjustment is carried out to calculate the offset amount corresponding to the magnitude of vibration after the detection of noise, and to eliminate the influence of noise the next time the seismic sensor 10 is actuated by using the calculated offset amount.

The calculated offset component is stored in the storage unit 30 and used for actuation determination executed by the vibration intensity classification and actuation determination unit 23, or earthquake determination executed by the earthquake determination unit 25. Also, the offset amount adjusted by the offset adjustment unit 29 is subjected to feedback control every time vibration is detected and an acceleration waveform is generated, and is updated and saved as an appropriate value according to the amount of noise.

Consequently, the offset amount is always set within the proper range, so that when sensing the frequency of the acceleration waveform, the frequency can be sensed very accurately.

As shown in FIG. 2, the offset adjustment unit 29 has a convergence determination unit 29a and an origin correction necessity determination unit 29b.

The convergence determination unit 29a determines whether or not the detected vibration has converged within a specific period (such as 1 second). More specifically, the convergence determination unit 29a determines whether or not the vibrations have converged depending on whether or not all the peak-to-peak values (p-p values) of the acceleration waveform are below a specific threshold (such as less than 100 gal) within a specific period.

The convergence determination unit 29a also determines whether or not the vibrations have converged after a specific time has elapsed since the determination by the earthquake determination unit 25.

The origin correction necessity determination unit 29b determines whether or not to perform origin correction of the acceleration waveform (acceleration) according to whether or not the offset amount calculated according to the magnitude of the vibration after the detection of noise is about the same as the previous offset amount at the point when a specific period (such as 5 to 20 seconds) has elapsed since the time when the convergence determination unit 29a determined that the vibrations had converged.

Then, the origin correction necessity determination unit 29b determines whether or not the seismic sensor 10 (main body part 10a) is tilted after the vibrations have converged, depending on whether the offset amount is about the same as the previous offset amount. That is, the origin correction necessity determination unit 29b compares the offset amount calculated after the vibration convergence with the previous offset amount, and if it is determined that the calculated offset amount is larger than the previous offset amount, it is presumed that the main body part of the seismic sensor 10 is still tilted, but if is determined that the calculated offset amount is about the same as the previous offset amount, it is presumed that the tilting of the main body part of the seismic sensor 10 is almost completely gone.

Then, if the origin correction necessity determination unit 29b determines that the offset amount is about the same as the previous offset amount, the offset adjustment unit 29 uses the new offset amount to perform offset adjustment.

Also, if it is determined by the origin correction necessity determination unit 29b that the offset amount calculated after a specific period of time has elapsed since the vibrations converged (such as when 5 to 20 seconds have elapsed) is greater than the previous offset amount, the offset adjustment unit 29 uses this offset amount to perform offset adjustment including origin correction of the acceleration waveform.

Here, if the origin correction necessity determination unit 29b determines that origin correction is necessary, the offset adjustment unit 29 corrects any deviation in the direction of the gravitational acceleration by performing origin correction of the acceleration in a horizontal plane. That is, the offset adjustment unit 29 performs origin correction of acceleration in the X axis and Y axis directions (horizontal direction), assuming that the vertical direction is the Z axis, for example.

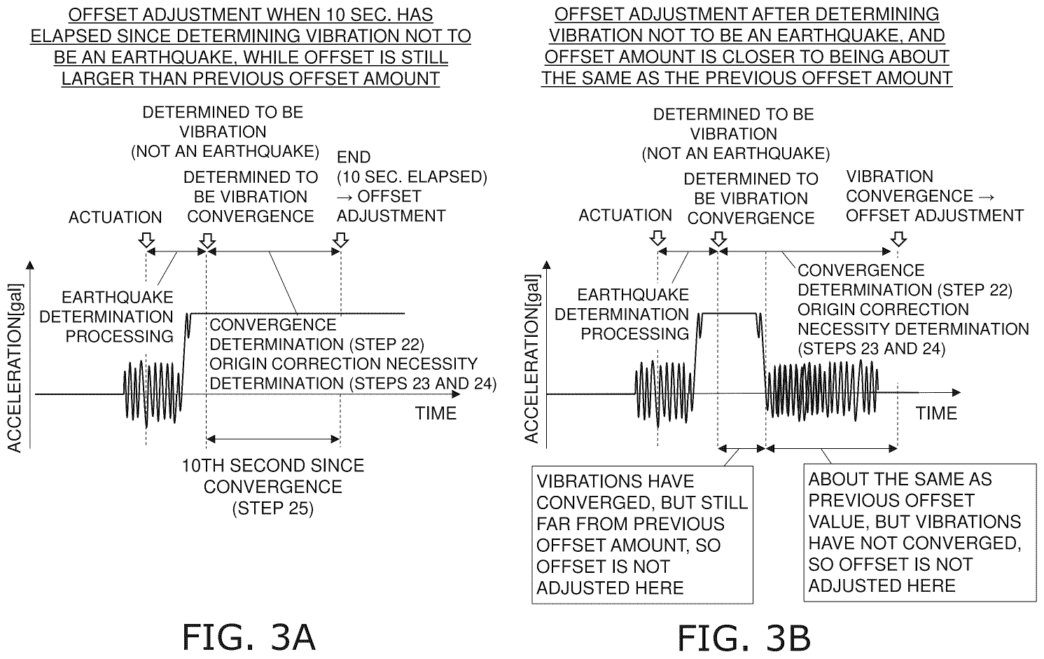

More precisely, as shown in FIG. 3A, for example, if the earthquake determination unit 25 determines that the vibration detected by the acceleration acquisition unit 21 is not an earthquake, and the calculated offset amount is still greater than the previous offset amount after 5 to 20 seconds have elapsed, then the offset adjustment unit 29 performs offset adjustment.

FIG. 3A shows the acceleration waveform when the seismic sensor 10 is still tilted after vibration has been detected, and stays this way until a specific period of time has elapsed (such as 5 to 20 seconds) since the vibrations converged.

In this case, the seismic sensor 10 is actuated immediately after detection of the vibration, the earthquake determination unit 25 determines that it is not an earthquake but a vibration, and the origin correction necessity determination unit 29b performs origin correction necessity determination by calculating the offset amount according to the magnitude of vibration after detection of the noise included in the acceleration waveform within specific period of time (such as 5 to 20 seconds) since the convergence determination unit 29a determined that the vibrations had converged.

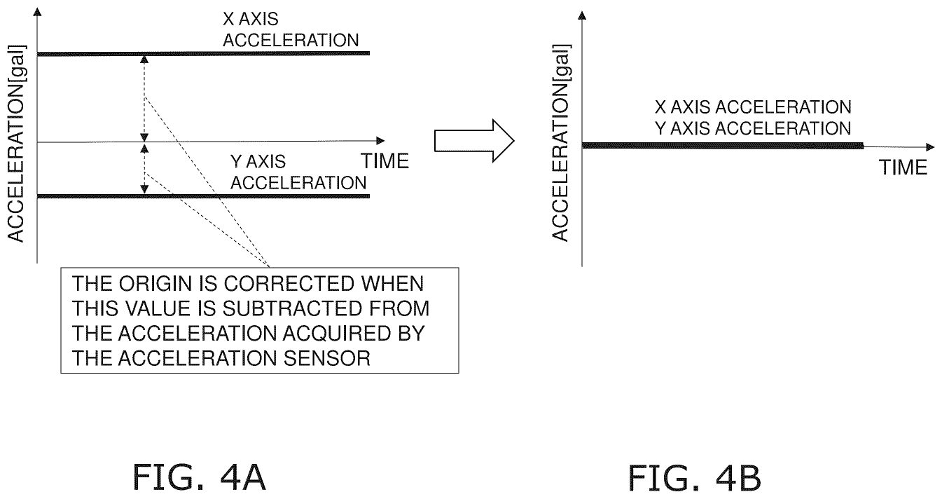

When the origin correction necessity determination unit 29b determines that origin correction is necessary, this means that the X-axis acceleration component and the Y-axis acceleration component caused by tilting of the seismic sensor 10 need to be subjected to offset adjustment processing to achieve the state shown in FIG. 4B, in a horizontal plane (the X-Y plane when the Z axis is the vertical direction), as shown in FIG. 4A, for example.

At this time, the origin correction necessity determination unit 29b compares the calculated offset amount with the previous offset amount stored in the storage unit 30 and determines whether or not the two amounts are about the same size.

Then, in the case of FIG. 3A, the origin correction necessity determination unit 29b determines that the offset amount calculated 5 to 20 seconds after the vibration convergence larger than the previous offset amount stored in the storage unit 30, so it is presumed that the seismic sensor 10 is still tilted, and therefore it is determined that origin correction is necessary. Consequently, in this case, the offset adjustment unit 29 performs offset adjustment including origin correction by using the offset amount calculated 5 to 20 seconds after the vibration convergence.

As a result, even if the seismic sensor 10 is still tilted due to vibration, highly accurate vibration detection can be performed that takes into account the tilting of the seismic sensor 10.

FIG. 3B shows the acceleration waveform when the seismic sensor 10 has tilted due to vibration after the vibration was detected (such as low-frequency vibration) and has returned to almost its original attitude after the vibration convergence, for example.

In this case, the seismic sensor 10 is actuated immediately after detection of the vibration, the earthquake determination unit 25 determines that it is not an earthquake but a vibration, and the convergence determination unit 29a determines whether or not the vibration has converged. At the same time, the origin correction necessity determination unit 29b calculates an offset amount according to the magnitude of vibration after detecting noise included in the acceleration waveform, and determines whether origin correction is necessary.

In the case of FIG. 3B, the origin correction necessity determination unit 29b determines that the offset amount calculated after the vibration converged has decreased to almost the same as the previous offset amount stored in the storage unit 30, and it is therefore presumed that the tilt of the seismic sensor 10 was temporary. Consequently, in this case, the offset adjustment unit 29 performs offset adjustment using the newly calculated offset amount.

As a result, if the seismic sensor 10 was temporarily tilted due to vibration, but returns to its original attitude after a specific period of time has elapsed, very accurate vibration detection can be performed by performing offset adjustment using a new offset amount.

In the graph shown in FIG. 3B, vibration is detected again after the vibrations have converged, so offset adjustment is performed after the vibration converges, without performing any offset adjustment up until the vibration again converges.

The storage unit 30 stores acceleration data acquired by the acceleration acquisition unit 21, filtered acceleration data, determination results from the earthquake determination unit 25, offset component data (offset amount) used in the offset adjustment unit 29, and so forth, for example.

### Earthquake Detection Method

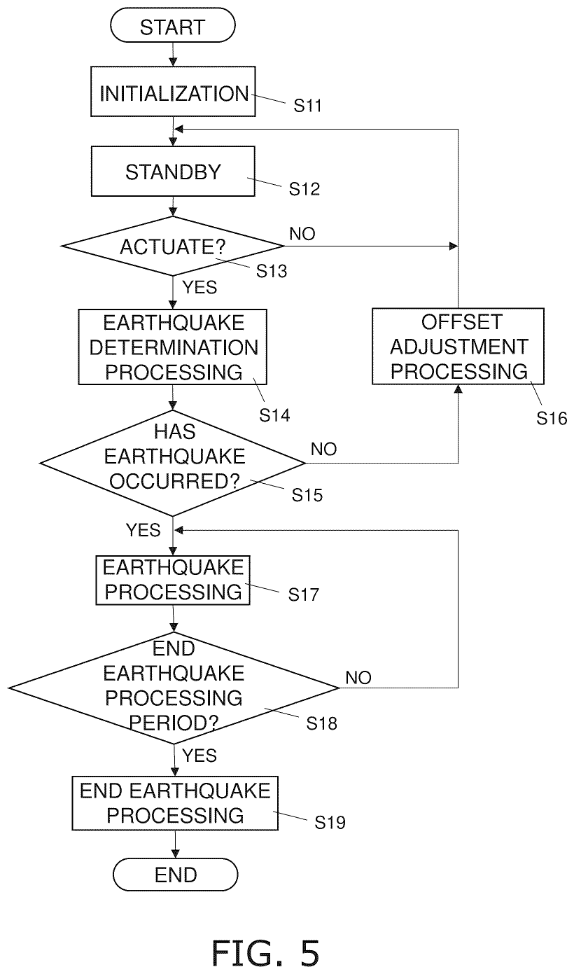

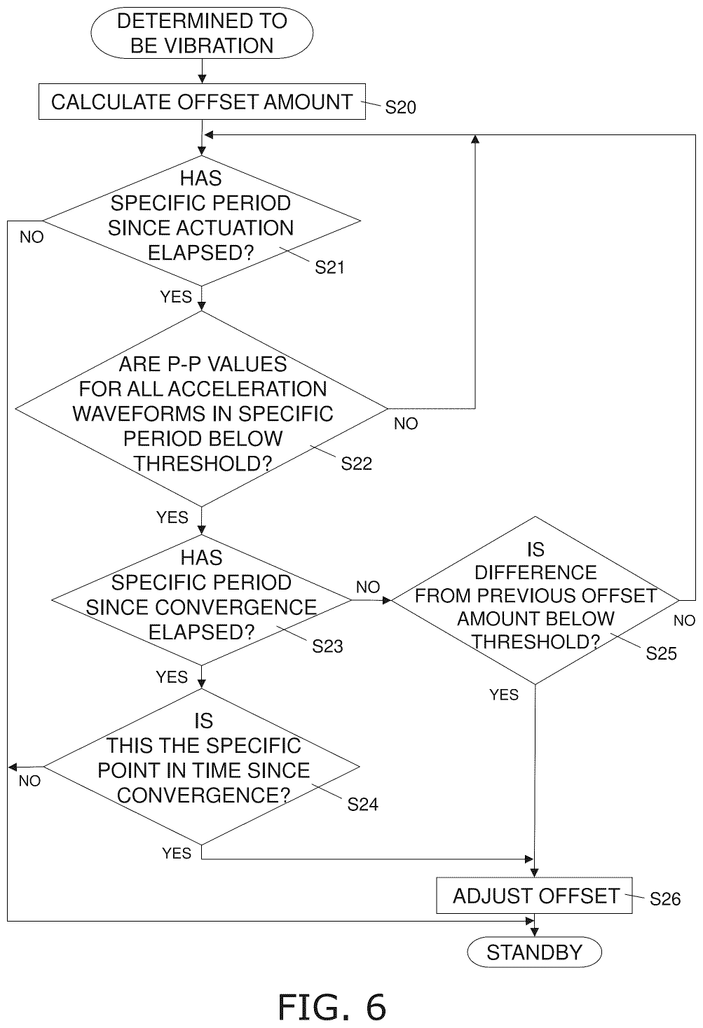

An earthquake detection method featuring the seismic sensor 10 of this embodiment will now be described through reference to the flowcharts in FIGS. 5 and 6.

FIG. 5 is a processing flow diagram showing an example of earthquake detection processing by the seismic sensor 10 in this embodiment.

With the seismic sensor 10 in this embodiment, when an acceleration of at least a specific value is detected, the seismic sensor 10 changes from its standby state (power saving mode) to measurement mode and performs earthquake determination processing, and if it is determined that an earthquake has occurred, the system changes to earthquake processing, and if the magnitude of the earthquake is at or above a certain level, processing is performed to output a shutdown signal to related equipment.

The processing shown in FIG. 5 is repeatedly performed in the seismic sensor 10.

In the seismic sensor 10, first, in step S11, various kinds of data, such as various threshold values and offset amounts that are stored in the memory 13 or the storage unit 30, etc., in the seismic sensor 10 and are used for earthquake detection processing, are initialized.

Next, in step S12, the seismic sensor 10 is kept in its standby state. More specifically, the acceleration acquisition unit 21 of the seismic sensor 10 acquires the acceleration measured by the acceleration sensor 11 in power saving mode (acceleration acquisition step).

The acceleration acquisition unit 21 performs low-speed sampling in the standby state.

Next, in step S13, the vibration intensity classification and actuation determination unit 23 of the seismic sensor 10 determines whether or not to actuate the seismic sensor 10 (that is, whether or not to change from power saving mode to measurement mode).

In this step, if the acceleration measured in the standby state is at or below a specific actuation threshold (a relative value based on the offset) (No in S13), the processing goes back to step S12 and the standby state (power saving mode) is continued. Here, the actuation threshold is a value expressing acceleration, such as 50 gal, and is initialized in step S11 and stored in the storage unit 30.

On the other hand, if the acceleration measured in the standby state is over the actuation threshold (Yes in S13), the acceleration acquisition unit 21 transitions to earthquake determination processing (measurement mode) in step S14. The acceleration acquisition unit 21 performs high-speed sampling in the earthquake determination processing (measurement mode).

Next, in step S14, the acceleration acquisition unit 21 measures acceleration by high-speed sampling in earthquake determination processing (measurement mode), performs filtering on the measured acceleration, and stores the resulting value in the storage unit 30 (earthquake determination processing). The filtering may be executed by the controller 12 in transitioning to the active mode, or may be executed by the acceleration sensor 11 while the controller 12 is still in sleep mode. Filtering is not essential in the earthquake determination processing.

Next, in step S15, it is determined whether or not the detected vibration is an earthquake (earthquake determination processing). More specifically, the earthquake determination unit 25 determines whether or not the detected vibration is an earthquake according to whether or not the acceleration value measured in the earthquake determination processing of step S14 satisfies a specific condition.

For example, the earthquake determination unit 25 determines that an earthquake has occurred if the difference between the maximum and minimum values (peak-to-peak) of acceleration measured in the determination period is at or above a specific threshold (such as 100 gal).

Consequently, if it is determined in step S15 that an earthquake has occurred (Yes in S15), the processing proceeds to earthquake processing in step S17.

Next, in the offset adjustment processing of step S16, since the detected vibration was determined not to be an earthquake in the earthquake determination processing of step S15, the offset adjustment unit 29 performs offset adjustment by calculating the offset amount according to the magnitude of vibration after the detection of noise included in the acceleration waveform indicating the vibration.

In this step, as offset adjustment processing, the offset amount is adjusted by finding the average value of acceleration from the acceleration waveform, for example. Once the offset adjustment processing in step S16 is finished, the processing goes back to the standby state in step S12.

The offset adjustment processing in step S16 will be explained in detail below using the flowchart shown in FIG. 6.

Next, in step S17, since the detected vibration was determined to be an earthquake in the earthquake determination processing of step S15, the earthquake magnitude calculation unit 27 of the seismic sensor 10 calculates an evaluation index (such as the SI value) indicating the magnitude of the earthquake. In calculating this evaluation index, the controller 12 operates in active mode.

Here, if the calculated evaluation index is above a specific threshold value, it is determined that an earthquake of greater than expected intensity has occurred, and the evaluation index (SI value) is outputted to an external device (not shown) to which the seismic sensor 10 is connected. Then, a cutoff signal for cutting off the supply of energy, such as gas or electricity, is outputted from this external device, and the gas or electricity is cut off.

Next, in step S18, it is determined whether or not the earthquake processing period has ended. This earthquake processing period is a period that is initialized in advance in step S11, and may be a period of 120 seconds, for example.

If it is determined in step S18 that the earthquake processing period has not yet ended, the processing goes back to step S17 and the earthquake processing is continued. On the other hand, if it is determined in step S18 that the earthquake processing period has ended, the processing proceeds to step S19.

Next, in step S19, the earthquake processing is ended, the calculation of the SI value is also ended, and the SI value is reset. When the processing of step S19 ends, the process of this routine is temporarily halted.

The seismic sensor 10 in this embodiment executes the offset adjustment processing of step S16 included in the processing of the earthquake detection method shown in FIG. 5, according to the flowchart shown in FIG. 6.

The flowchart in FIG. 6 shows the flow of the offset adjustment processing in step S15 in FIG. 5 when the detected vibration is determined not to be an earthquake, that is, to be a vibration, and the processing has proceeded to step S16.

That is, in step S20, the acceleration acquisition unit 21 acquires vibration acceleration data, and the offset adjustment unit 29 calculates an offset amount.

Next, in step S21, if the detected vibration is not an earthquake, the offset adjustment unit 29 determines whether or not a specific length of time (such as 40 seconds) has elapsed since the seismic sensor 10 was actuated. Here, if this specific length of time has not elapsed, the processing proceeds to step S22, and otherwise the system goes into the standby state.

Next, in step S22, since it was determined in step S21 that the specific length of time (such as 40 seconds) had not yet elapsed, the convergence determination unit 29a determines whether or not the p-p peak-to-peak values of all accelerations during a specific period (such as one second) are below a specific threshold (such as 70 to 100 gal) (convergence determination step) in order to confirm the convergence state of the vibration. Here, if the p-p values of all the accelerations are below the threshold value, the processing proceeds to step S23, and if they are at or above the threshold value, the processing goes back to step S21.

Next, in step S23, since it was determined in step S22 that all the acceleration p-p values were below the threshold, the origin correction necessity determination unit 29b determines whether or not a specific period (such as 5 to 20 seconds) has elapsed since the vibrations converged (origin correction necessity determination step). Here, if the specific period has elapsed since the convergence, the processing proceeds to step S24, and otherwise the processing proceeds to step S25.

Next, in step S24, since it was determined in step S23 that a specific period of time (such as 5 to 20 seconds) had elapsed since the vibrations converged, the origin correction necessity determination unit 29b determines whether or not it is a specific point in time (such as the fifth to 20th second) (origin correction necessity determination step). Here, if it is the specific point time (such as the fifth to 20th second) after the vibration convergence, the processing proceeds to step S26, but if the specific period has elapsed, it is determined that vibration was detected again during the determination and offset adjustment is impossible, and the system goes into standby state.

Next, in step S25, since it was determined in step S23 that the specific period had not elapsed since the vibrations converged, the origin correction necessity determination unit 29b determines whether or not the difference between the offset amount calculated in step S20 and the previous offset amount is below a specific threshold value (such as 10 to 30 gal) (origin correction necessity determination step). Here, if the difference is below the threshold value, the processing proceeds to step S26. On the other hand, if the difference is at or above the threshold, it is determined that the current offset amount deviates from the previous offset amount, and the processing goes back to step S21 without any offset adjustment being performed, and the processing from step S21 onward is repeated.

Consequently, until a specific period has elapsed since the vibration convergence, the processing proceeds to step S25, the current offset amount and the previous offset amount are compared, and it is determined whether or not the difference is below the threshold value (10 to 30 gal), and if the difference is at or above the threshold, origin correction necessity determination processing can be repeated until the difference becomes drops under the threshold.

Next, in step S26, since it was determined in step S24 that it was a specific point in time since the vibrations converged (such as the fifth to 20th second), or it was determined in step S25 that the difference between the current offset amount and the previous offset amount was below the threshold, the offset adjustment unit 29 performs offset adjustment using the offset amount calculated at the specific point in time, or performs offset adjustment using a new offset amount (calculated in step S20) whose difference from the previous offset amount is below the threshold (offset adjustment step).

Consequently, the determination processing in steps S21 to S23 and step S25 is repeated until a specific length of time has elapsed since the vibration convergence, and if the difference from the previous offset amount does not fall below the threshold by the specific point in time after the vibration convergence, offset adjustment can be performed by using the offset amount calculated after the specific period has passed.

### Main Features

The seismic sensor 10 of this embodiment comprises the acceleration acquisition unit 21, the earthquake determination unit 25, the offset adjustment unit 29, the convergence determination unit 29a, and the origin correction necessity determination unit 29b. The acceleration acquisition unit 21 detects vibration and acquires the acceleration of the vibration. The earthquake determination unit 25 determines whether or not the vibration is an earthquake on the basis of the acceleration acquired by the acceleration acquisition unit 21. The offset adjustment unit 29 adjusts the offset amount according to the magnitude of the vibration after the detection of noise included in the vibration detected by the earthquake determination unit 25. The convergence determination unit 29a determines whether or not the vibrations have converged. The origin correction necessity determination unit 29b determines whether or not to perform the origin correction of acceleration according to whether or not the offset amount calculated according to the magnitude of the vibration detection as noise is about the same as the previous offset amount at the point when a specific period of time has elapsed since the time when the convergence determination unit 29a determined that the vibrations had converged.

Consequently, if it is determined that the current offset amount is about the same as the previous offset amount after a specific period of time has elapsed (such as 5 to 20 seconds) since the vibration convergence, it is presumed that there is almost no tilting of the seismic sensor, but if the difference is large compared to the previous offset amount, it is presumed that there is a high probability that the seismic sensor is still tilted.

Therefore, if this tilting continues for at least a specific length of time after the vibrations have converged, the offset amount including origin correction is adjusted in the tilted state, and if the tilting does not continue for a specific length of time, offset adjustment can be performed using the new offset amount in which the tilting has returned to normal. As a result, vibrations can be evaluated very accurately by eliminating the influence of temporary tilting that occurs immediately after the vibrations occur.

### Other Embodiments

An embodiment of the present invention was described above, but the present invention is not limited to or by the above embodiment, and various changes can be made without departing from the gist of the invention.

### (A)

In the embodiment described above, an example was given in which the present invention was realized as a seismic sensor and an earthquake detection method. However, the present invention is not limited to this.

For example, the present invention may be realized as an earthquake detection program that causes a computer to execute an earthquake detection method in which the seismic sensor described above is used.

This earthquake detection program is stored in a memory (storage unit) installed in the seismic sensor, and the CPU reads the earthquake detection program stored in the memory and causes the hardware to execute the various steps. More specifically, the same effect as above can be obtained when the CPU reads the earthquake detection program and executes the above-mentioned acceleration acquisition step, earthquake determination step, offset adjustment step, convergence determination step, and origin correction necessity determination step.

Also, the present invention may be realized as a recording medium that stores an earthquake detection program for a seismic sensor.

### (B)

In the above embodiment, an example was given in which the magnitude of vibration after the offset adjustment unit 29 detected noise included in the vibration waveform was calculated at the point when a specific period (such as 5 to 20 seconds) had elapsed after it was determined that the detected vibration had converged, and the origin correction necessity determination unit 29b determined whether or not the offset amount was about the same as the previous offset amount. However, the present invention is not limited to this.

For example, instead of slow vibration waveforms such as those found with low-frequency vibrations, the configuration may be such that situations such as when the seismic sensor is tilted due to an external impact, etc., are taken into account, the offset amount is calculated when a longer or shorter amount of time has elapsed since the vibration convergence, and this offset amount is compared with the previous offset amount.

### (C)

In the above embodiment, an example was given in which the offset adjustment unit 29 performed offset adjustment of the acceleration waveform when the earthquake determination unit 25 had determined that the detected vibration was not an earthquake. However, the present invention is not limited to this.

For example, the configuration may be such that even if it is determined that the detected vibration is an earthquake, the offset adjustment is performed as necessary.

### (D)

In the above embodiment, an example was given in which the output control unit 28 controlled the output unit 14 such that a cutoff signal to halt the supply of energy such as electricity or gas was outputted when the vibration detected as an earthquake was equivalent to a seismic intensity of at least 5. However, the present invention is not limited to this. For example, the configuration may be such that the output control unit controls the output unit so as to output a warning signal that alerts the user to the occurrence of an earthquake.

### (E)

In the above embodiment, an example was given in which the determination of whether or not an acceleration waveform generated by sensing vibration acceleration is to be excluded from earthquake determination was carried out according to whether or not the frequency was at least 10 Hz. However, the present invention is not limited to this.

For example, the specific value for determining whether or not to exclude an acceleration waveform from earthquake determination is not limited to 10 Hz, and may be a value larger than 10 Hz or a value smaller than 10 Hz.

### (F)

In the above embodiment, an example was given in which the determination of whether or not the acceleration waveform generated by sensing the acceleration of vibration is to be excluded from earthquake determination target was carried out according to whether or not the amplitude of the acceleration waveform was at least 700 gal. However, the present invention is not limited to this.

For example, the determination condition related to the amplitude of the acceleration waveform is not limited to the above numerical range, and may be some other condition.

### (G)

In the above embodiment, an example was given in which the determination of whether or not an earthquake had occurred was carried out according to the frequency of the acceleration waveform, as well as monotonous attenuation, period fluctuation, amplitude, the presence or absence of a vibration stop period, and so forth. However, the present invention is not limited to this.

For example, examples of a determination means that does not involve the magnitude of the frequency of the acceleration waveform include one or more of the above means, as well as means other than the above means.

### (H)

In the above embodiment, an example was given in which the invention was applied to the seismic sensor 10 that performs earthquake determination. However, the present invention is not limited to this.

For example, the present invention may be applied to various kinds of product in which the sensing state of an acceleration sensor changes due to vibration or the like, without making any earthquake determination.

### INDUSTRIAL APPLICABILITY

The seismic sensor of the present invention exhibits the effect that the evaluation of vibration can be performed very accurately by eliminating the influence of temporary tilting that occurs immediately after the occurrence of a vibration, and as such is widely applicable to various kinds of apparatus.

### EXPLANATION OF REFERENCE

10 seismic sensor
10a main body part
11 acceleration sensor
12 controller
13 memory
14 output unit
21 acceleration acquisition unit
22 acceleration waveform generation unit
23 vibration intensity classification and actuation determination unit
24 frequency sensing unit
25 earthquake determination unit
26 vibration stop period determination unit
27 earthquake magnitude calculation department
28 output control unit
29 offset adjustment unit
29a convergence determination unit
29b origin correction necessity determination unit
30 storage unit

1. A seismic sensor, comprising:
an acceleration acquisition unit configured to detect vibration and acquires an acceleration of the vibration;
an earthquake determination unit configured to determine whether the vibration is an earthquake on the basis of the acceleration acquired by the acceleration acquisition unit;
an offset adjustment unit configured to adjust an offset amount according to a magnitude of the vibration after detecting noise included in the vibration detected by the earthquake determination unit;
a convergence determination unit configured to determine whether the vibrations have converged; and
an origin correction necessity determination unit configured to determine whether or not to perform origin correction of the acceleration according to whether or not the offset amount calculated according to the magnitude of the vibration after the noise was detected is the same as the previous offset amount once a specific length of time has elapsed since a point when the convergence determination unit determined that the vibrations had converged.

2. The seismic sensor according to claim 1,
wherein, when the offset amount is about the same as the previous offset amount, the offset adjustment unit performs offset adjustment using the new offset amount.

3. The seismic sensor according to claim 1,
wherein, once the specific length of time has elapsed, the offset adjustment unit uses an offset amount that is larger than the previous offset amount to perform offset adjustment including origin correction of the acceleration.

4. The seismic sensor according to claim 1,
wherein the convergence determination unit determines whether or not the vibrations have converged after a specific time has elapsed since a determination by the earthquake determination unit.

5. The seismic sensor according to claim 1,
wherein, when the origin correction necessity determination unit determines that origin correction is necessary, the offset adjustment unit performs origin correction of acceleration in a horizontal plane to correct deviation in a direction of gravitational acceleration.

6. The seismic sensor according to claim 1,
wherein the offset adjustment unit adjusts the offset amount when the earthquake determination unit determines that the vibration is not an earthquake.

7. The seismic sensor according to claim 1,
further comprising a main body part to which the acceleration acquisition unit is provided,
wherein the origin correction necessity determination unit determines whether the main body part is tilted after the vibrations have converged, according to whether or not the offset amount is about the same as the previous offset amount.

8. The seismic sensor according to claim 1,
further comprising an acceleration waveform generation unit configured to generate an acceleration waveform indicating a relation between elapsed time and the acceleration acquired by the acceleration acquisition unit.

9. The seismic sensor according to claim 8,
further comprising a frequency sensing unit configured to sense a frequency of the acceleration waveform generated in the acceleration waveform generation unit.

10. The seismic sensor according to claim 9,
wherein the earthquake determination unit determines whether or not the vibration is an earthquake on the basis of the frequency sensed by the frequency sensing unit.

11. The seismic sensor according to claim 1,
further comprising an earthquake magnitude calculation unit configured to determine whether or not the earthquake is at or over a specific seismic level when the earthquake determination unit has determined that it is an earthquake.

12. The seismic sensor according to claim 1,
further comprising an output unit configured to output a specific signal when the earthquake determination unit has determined that it is an earthquake.

13. The seismic sensor according to claim 11,
further comprising an output unit configured to output a specific signal when the earthquake determination unit has determined that it is an earthquake, and
further comprising an output control unit configured to control the output of a signal from the output unit according to whether the magnitude of the earthquake calculated by the earthquake magnitude calculation unit is at or above a specific seismic level.

14. The seismic sensor according to claim 12,
wherein the specific signal is a cutoff signal that halts a supply of energy.

15. The seismic sensor according to claim 12,
wherein the specific signal is a warning signal that gives a warning to a user.

16. The seismic sensor according to claim 1,
further comprising a storage unit configured to store the offset amount.

17. An earthquake detection method, comprising:
detecting vibration and acquiring an acceleration of the vibration;
determining whether or not the vibration is an earthquake on the basis of the acceleration of the vibration acquired;
adjusting an offset amount according to a magnitude of the vibration after a detection of noise included in the vibration detected;
determining whether or not the vibrations have converged; and
determining whether or not an origin correction of the acceleration is to be performed, according to whether or not the offset amount calculated according to the magnitude of the vibration after the detection of noise is the same as the previous offset amount, at a point when a specific length of time has elapsed since the time when it was determined that the vibrations had converged.

18. An earthquake detection program that causes a computer to execute an earthquake detection method comprising:
detecting vibration and acquiring an acceleration of the vibration;
determining whether or not the vibration is an earthquake on the basis of the acceleration of the vibration acquired;
adjusting an offset amount according to a magnitude of the vibration after a detection of noise included in the vibration detected;
determining whether or not the vibrations have converged; and
determining whether or not an origin correction of the acceleration is to be performed, according to whether or not the offset amount calculated according to the magnitude of the vibration after the detection of noise is the same as the previous offset amount, at a point when a specific length of time has elapsed since the time when it was determined that the vibrations had converged.
